(19) United States
(12) Patent Application Publication
(10) Pub. No.: US 2005/0177384 A1
(43) Pub. Date: Aug. 11, 2005

(54) System and method for designing and building e-business systems

(76) Inventors: Donald A. Cronin, Raleigh, NC (US); David H. Janson, Raleigh, NC (US)

Correspondence Address: COATS & BENNETT, PLLC, P O BOX 5, RALEIGH, NC, 27602, US

(21) Appl. No.: 10/775,643

(22) Filed: Feb. 10, 2004

(51) Int. Cl. G06F 17/60

(52) U.S. Cl. 705/1

(57) ABSTRACT

A method of architecting, designing and building an e-business system includes identifying one or more domains relevant to the design and implementation of the e-business system. Each domain includes one or more patterns having domain-specific information. A system designer, for example, generates an intermediate set of patterns by selecting patterns from one or more of the identified domains according to predetermined criteria. The designer then refines the intermediate set of patterns by applying increasingly narrower criteria to the intermediate set of patterns. Combining patterns in the intermediate set of patterns then produces a multi-domain pattern that defines various components of the e-business system.

### BACKGROUND

The present invention relates generally to e-business systems, and more particularly, to a system and method of designing and building an e-business system.

Providing an e-business system to a customer is a complex undertaking that demands the consideration of a wide range of disciplines. Security, performance, system access, and functionality are just some of the domains that system designers must consider when designing the hardware and software components that define the system. To simplify design, designers often consider the system in terms of separate domains, and produce a separate solution for each domain. The separate solutions are then integrated during implementation.

While this approach may make it easier to design the system, it can also lead to inefficient, incomplete, or incorrect solutions that cost far more to deliver and maintain than originally expected. For example, because each domain is separately considered, potential conflicts between system components may not be known until after design is complete and the various solutions are implemented. In addition, interoperability between components may suffer. Addressing each of the various domains as it relates to the other domains may uncover such incompatibilities.

### SUMMARY

The present invention provides a method of designing and building an e-business system. The method comprises identifying one or more domains relevant to the e-business system. Each domain represents a different set of problems to be considered, and includes one or more patterns having information specific to its domain. A system designer generates an intermediate set of patterns by selecting one or more patterns from one or more of the domains according to predetermined criteria. The designer may then progressively refine the patterns in the intermediate set of patterns, and combine the patterns to produce a multi-domain pattern. The multi-domain pattern defines the components of the eBusiness system.

In one embodiment, the method may be performed by a system comprising a server, a database communicatively linked to the server, and a controller communicatively linked to both the server and the database. The controller may be adapted to display one or more domains to a user, wherein each domain includes one or more patterns having domain specific information. The designer interacts with the system to generate an intermediate set of patterns by selecting one or more patterns from one or more of the identified domains based on predetermined criteria. Combining patterns in the intermediate set of patterns produces a multi-domain pattern that defines the components of the eBusiness system.

### BRIEF DESCRIPTION OF THE DRAWINGS

FIG. 1 illustrates one embodiment of a software component for performing a method of the present invention.

FIG. 2 illustrates one embodiment of a system on which the software component of FIG. 1 may run.

FIG. 3 illustrates one embodiment of a possible method of the present invention.

### DETAILED DESCRIPTION

The present invention provides a system and method of architecting, designing and building an e-business system by combining one or more domain patterns to produce a multi-domain pattern. Domain patterns comprise information specific to a given domain, while the multi-domain pattern comprises the combined information from one or more of the domain patterns. The multi-domain pattern is then used to build the hardware and software components of the e-business system.

As used herein, a pattern is defined as a template or component that includes information that has proven successful in solving a recurring problem. A designer may use a pattern as a starting point, and then modify the pattern according to varying criteria, or use the pattern as-is. Patterns may comprise, alone or in combination, software solutions (e.g., design patterns, architectural patterns, analysis patterns, business process patterns, code modules, etc.), hardware solutions (machine types, processor types, memory requirements, etc.), documentation, network maps, and various other parameters as needed or desired. As will be described in more detail below, patterns may be stored in memory on a computer system so that the designer or other personnel may select and/or modify the various pattern components.

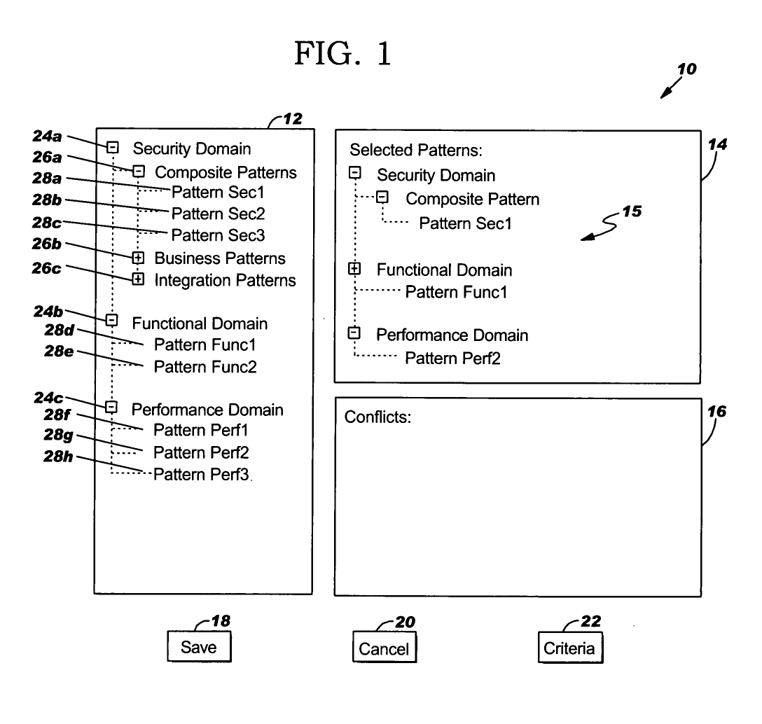

Referring now to FIG. 1, the present invention may be embodied, for example, as software executing on a computer system. Any computer language known in the art, such as C/C++ or Java, may be used to implement the software. Display 10 comprises a pattern window 12, a selected patterns window 14, and a conflicts window 16. A save button 18, cancel button 20, and a criteria button 22, allow the designer to interact with the software.

Pattern window 12 organizes domains 24 into logical groupings for the designer. This embodiment illustrates domains 24 as a security domain 24a, a functional domain 24b, and a performance domain 24c; however, other domains not specifically identified herein may be included as required or desired. Each domain 24 includes one or more domain patterns 28 that define known solutions to recurring problems particular to its domain 24. In FIG. 1, security domain 24a comprises one or more patterns 28a, 28b, 28c that have proven successful in solving past security issues, such as those relating to remote access, firewalls, or secure transactions over the Internet. Functional domain 26b comprises patterns 28d, 28e that have proven successful in solving past problems relating to e-business system functionality, while performance domain 26c comprises one or more patterns 28f, 28g, 28h that have proven successful in solving past problems relating to e-business system performance.

The patterns 28 within each domain 24 may be grouped into classifications 26 according to the types of problems they are known to solve. For example, the security domain in FIG. 1 classifies patterns 28 into composite patterns 26a (e.g., patterns that are a composite of several classifications of patterns), business patterns 26b (e.g., patterns that relate to business security), and integration patterns 26c (e.g., patterns that relate to the integration of various security components). Other classifications may be included or defined as desired.

The selected patterns window 14 displays patterns an intermediate set of patterns 15, which includes one or more patterns 28 selected by the designer. To generate the intermediate set of patterns 15, the designer simply selects the desired patterns 28 from the pattern window 12 according to predetermined criteria. In the embodiment of FIG. 1, the designer expands each domain 24 and classification 26, and double-clicks on “PATTERN Sec1” 28a, “PATTERN Func1” 28d, and “PATTERN Perf2” 28g. These selected patterns 28a, 28d, and 28g then appear in the selected patterns window 14 as part of the intermediate set of patterns 15, and are associated with the e-business system. For example, one embodiment of the present invention associates the selected patterns 28a, 28d, and 28g by creating and/or modifying a file stored in memory that includes links to the various pattern components (e.g., software, hardware definitions, documentation, network maps, or various other parameters) stored in memory.

Those skilled in the art will appreciate that the designer may select patterns 28 singularly, or in groups. Further, the present invention is not limited to selection by expanding lists and double-clicking on. Designers may also select various patterns 28 from a list box, by clicking on one or more radio buttons or check boxes, or simply by dragging and dropping the desired pattern 28 into the selected patterns window 14.

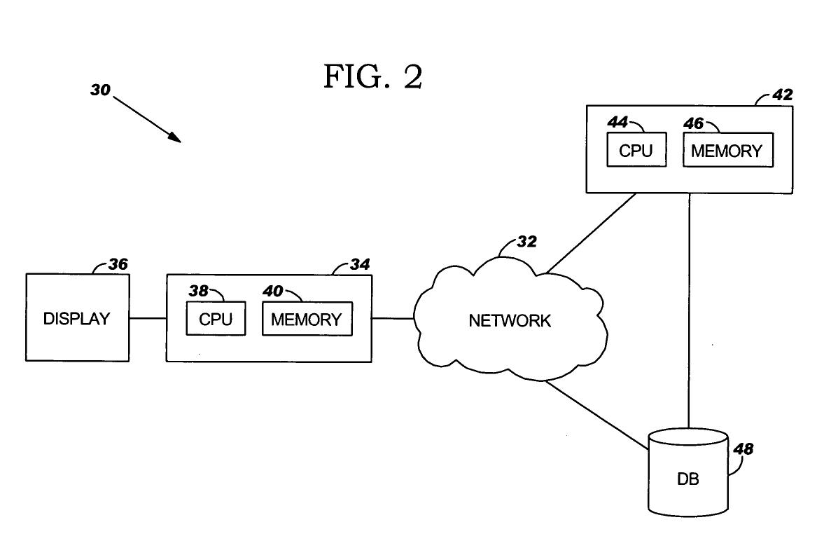

The criteria that the designer uses to select desired patterns 28 are accessible by clicking on criteria button 22. The criteria may encompass customer requirements and/or industry regulations, and may be stored in memory 40, 46 (see FIG. 2), or in a database 48 (see FIG. 2). Clicking the criteria button 22 may launch a separate window (not shown) that displays the text of the criteria to the designer, or may provide links to documents in memory that describe the criteria. Criteria considered more significant than other criteria may be shown in highlighted text, for example, at various stages of pattern selection. The designer may indicate or identify which criteria is considered significant, and may store these indications in memory. This permits the designer to focus on criteria that is considered to be distinctive in making pattern selections. As described in more detail below, the criteria used by the designer become progressively narrower in scope with subsequent selections.

The conflict window 16 displays possible conflicts between the patterns 28 in the intermediate set of patterns 15, which allows the designer to identify and address possible problems early in the design process. Rules that define conflicts between selected patterns 28 in the intermediate set of patterns 15 may be collected and stored in memory 40, 46 (see FIG. 2) or in database 48 (see FIG. 2), and used to verify pattern interactions. The rules account for cross-domain interaction, domain integration, influences, and constraints that exist among the domains and patterns. The conflict check may be invoked when the designer clicks the save button 18, or alternatively, as the designer selects patterns 28 from the patterns window 12. Like the criteria, the conflicts may be displayed to the designer as text and/or links that direct the designer to various documents detailing the conflicts.

The save button 18 permits the user to save the intermediate set of patterns 15 at each stage of the process. As those skilled in the art will appreciate, clicking save button 18 may launch a window (not shown) that accepts a file name and location in memory to store the intermediate set of patterns 15.

The software may execute on a system 30 of the type shown in FIG. 2. System 30 comprises a network 32 that interconnects one or more workstations 34 with a server 42 and a database 48. Network 32 is intended to embrace the entire spectrum of computer networks, and include such exemplary networks as Local Area Networks (LANs), Wide Area Networks (WANs), and the Internet. It should be understood, however, that these types of networks are merely illustrative, and network 32 could encompass other types of networks not specifically listed here.

Workstation 34 comprises a display 36, a controller or microprocessor 38, and memory 40. Display 36 is any display known in the art, and outputs information to the designer, for example, display 10 of FIG. 1. Microprocessor 38 controls the operation workstation 34 according to programs stored in memory 40, and may be implemented as a single microprocessor, or as multiple microprocessors. Additionally, microprocessor 38 may be configured to execute the method of the present invention embodied as a software program. Memory 40 represents the entire hierarchy of memory in a computing device, and may include both random access memory (RAM) and read-only memory (ROM), as well as disk drives (e.g., hard drives, floppy disks) and CDs (i.e., readable and/or writable). In addition, software components and data may be stored in memory 40 as needed or required by an end user.

Server 42 may be any computing device capable of operating as a server on network 32, and comprises a microprocessor 44, and memory 46. Microprocessor 44 and memory 46 are similar in functionality to the microprocessor 38 and memory 40 described above, and thus, their functionality is not repeated here. It is sufficient to say that like microprocessor 38, microprocessor 44 may be adapted to execute the method of the present invention embodied as a software program stored in memory 46.

Database 48 may be any database in the art, proprietary or commercial, and may be stored in memory 46 on server 42. Alternately, however, database 48 may be stored on workstation 34 or other computing device that is separate from server 42, and linked to server 42 via network 44.

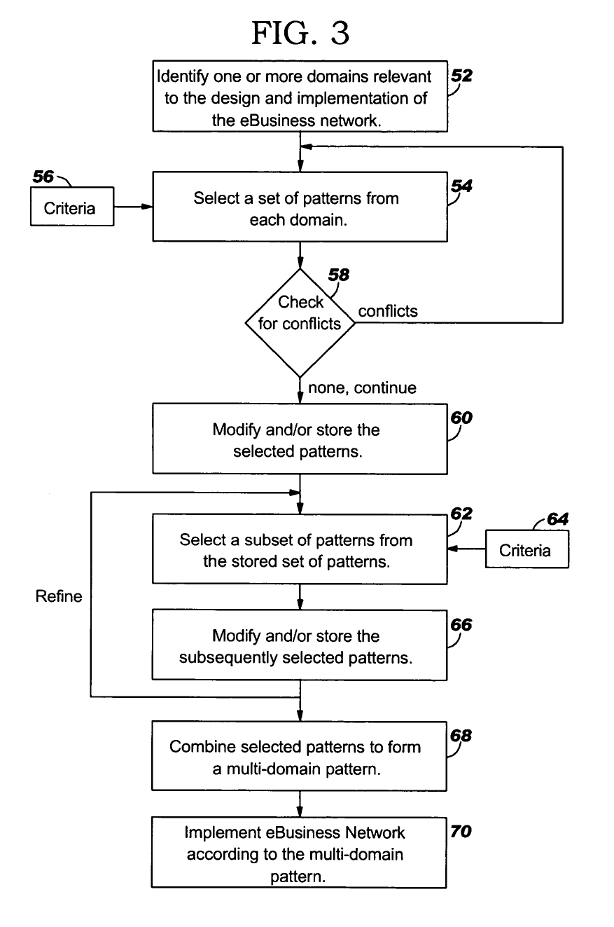

Turning now to FIG. 3, one embodiment of a method of the present invention is shown therein and indicated generally by the number 50. The method 50 begins with the identification of one or more domains 24 that are relevant to the design and implementation of the e-business system (box 52). As stated above, these domains 24 may include, but are not limited to, security domains 24a, functional domains 24b, and performance domains 24c. Once identified, the designer selects one or more patterns 28 (box 54) from each domain 24 to form the intermediate set of patterns 15 based on a first predetermined criteria (box 56). For example, a particular e-business system may require a certain type of server 42 or workstation 34, and may be required to interact with remote users over the Internet. Thus, the first criteria might encompass requirements for those types of servers 42 or workstations 34 having Internet capability that have proven successful in past implementations of other e-business systems. Using these criteria, the designer would select only those patterns 28 from one or more domains 24 that relate to servers 42 and workstations 34 that have Internet capability.

After the designer has selected the initial set of patterns 28, a conflict check (box 58) determines whether a possible conflict exists between the selected patterns 28 in the intermediate set of patterns 15. In a simplistic example, consider patterns 28a, 28d selected from the security domain 24a and the functional domain 24b, respectively. Each pattern 28a, 28d may provide hardware and/or software requirements for the server 32 or workstation 34 having Internet capability. However, while one of the patterns (e.g., 28a) may allow remote employee access, the other pattern 28d may block remote employee access. The conflict check (box 58) would permit the designer to identify this problem early in the design process, and take an appropriate form of action. For example, the designer may wish to select other more compatible patterns 28 from these domains 24, or simply modify one or both of the offending patterns 28a, 28d. Alternatively, criteria specifying remote employee access may not be well-defined at this stage of selection. Thus, the designer may simply wish to note the conflict and continue the process with the understanding that subsequent pattern selections based on narrower criteria will eventually eliminate the conflict. If no conflicts exist, or if the designer elects to continue with the conflicts, the designer may proceed to modify and/or save the patterns 28 in the intermediate set of patterns 15 to the database 48 (box 60).

Next, the designer selects a second set of patterns (box 62) by applying a second, narrower criteria (box 64) to the patterns 28 in the intermediate set of patterns 15. Continuing the above example, the second criteria may call for a server 34 that allows remote employee access, and that is able to handle a very high number of secure transactions. Thus, the designer would then refine the intermediate set of patterns 15 by selecting only those patterns 28 from the intermediate set of patterns 15 that relate to servers 34 that provide for remote employee access, and are able to handle a high number of secure transactions.

After selection, the designer may modify the patterns 28 in the intermediate set of patterns 15 before storing them in the database (box 66). A second conflict check (not shown) may be done to ensure compatibility of the patterns 28 in the intermediate set of patterns 15, to permit the designer to address any conflicts as previously described. This selection process may continue with the designer progressively refining the intermediate set of patterns 15 based on progressively narrower sets of criteria. That is, the designer progressively selects subsequent patterns 28 from the intermediate set of patterns 15 until the individual patterns required to build the system have been selected.

The final set of patterns includes one or more domain-specific patterns 28 from one or more of the identified domains 24. The designer may then combine the selected patterns in the intermediate set of patterns 15 to form a multi-domain pattern (box 68) that will be used to build and implement the e-business system (box 70). In one embodiment, combining the selected patterns into a multi-domain pattern comprises associating all the documentation, code, and other parameters for each selected pattern, and storing the association in the database 28. The association may be embodied as a file containing links to source code, documents, and/or other parameters as required or desired. Thereafter, the patterns 28 that define the multi-domain pattern, including any new or modified patterns, may be included in the database 28 and utilized by the designer to design and build subsequent e-business systems.

To support the incremental development through multiple levels of progressively more detailed selections, the tool distinguishes and saves each pattern set as a distinct design stage. The user can then review each stage separately, as well as make a copy of a particular stage to use as a starting point for other e-business systems. In this respect, intermediate sets of patterns and multi-domain patterns are re-usable, and can become new patterns in the repository.

The present invention may, of course, be carried out in other specific ways than those herein set forth without departing from the spirit and essential characteristics of the invention. The present embodiments are, therefore, to be considered in all respects as illustrative and not restrictive, and all changes coming within the meaning and equivalency range of the appended claims are intended to be embraced therein.

1. A method of designing and building an e-business system comprising:
identifying one or more domains, each said domain comprising one or more patterns having domain specific information;
generating an intermediate set of patterns having selected patterns from said one or more domains; and
combining patterns in said intermediate set of patterns to produce a multi-domain pattern, said multi-domain pattern defining components of said e-business system.

2. The method of claim 1 wherein said selected patterns are selected according to a first criteria.

3. The method of claim 2 further comprising progressively refining said intermediate set of patterns according to a second criteria.

4. The method of claim 3 wherein said second criteria is narrower than said first criteria.

5. The method of claim 1 wherein one of said domains comprises a security domain.

6. The method of claim 1 wherein one of said domains comprises a functional domain.

7. The method of claim 1 wherein one of said domains comprises a performance domain.

8. The method of claim 1 wherein said one or more patterns having domain specific information comprise business security patterns.

9. The method of claim 1 wherein said one or more patterns having domain specific information comprise eBusiness patterns.

10. The method of claim 1 further comprising storing said intermediate set of patterns in a database.

11. The method of claim 1 further comprising implementing said e-business system according to said multi-domain pattern.

12. The method of claim 1 wherein said multi-domain pattern defines one or more hardware components in said e-business system.

13. The method of claim 1 wherein said multi-domain pattern defines one or more software components in said e-business system.

14. A method of designing and building an e-business system comprising:
identifying a plurality of domains, each said domain comprising one or more patterns having domain specific information;
selecting a first set of patterns from one or more said domains based on a first criteria;
selecting a second set of patterns from said first set of patterns based on a second criteria, said second criteria being narrower in scope than said first criteria; and
generating a multi-domain pattern based on said second set of patterns, said multi-domain pattern defining components of said e-business system.

15. The method of claim 14 wherein one of said first and second criteria comprises criteria representative of a customer's requirements.

16. The method of claim 14 wherein one of said first and second criteria comprises criteria representative of industry regulations.

17. The method of claim 14 comprising storing said first and second criteria in a database.

18. The method of claim 17 further comprising storing said first and second sets of patterns in said database after said first and second sets of patterns are selected.

19. The method of claim 14 wherein selecting a first set of patterns from one or more said domains comprises displaying potential conflicts between said patterns in said first set of patterns.

20. The method of claim 14 wherein generating said multi-domain pattern comprises combining said second set of patterns.

21. The method of claim 20 wherein combining said second set of patterns comprises associating components of said second set of patterns in a file stored in a database.

22. The method of claim 14 further comprising implementing said e-business system according to said multi-domain pattern.

23. A system for designing and building an e-business system comprising:
a server;
a database communicatively linked to said server; and
a controller communicatively linked to said server and said database, said controller adapted to:
display one or more domains to a user, wherein each said domain includes one or more patterns having domain specific information;
generate an intermediate set of patterns having selected patterns from said one or more domains according to a predetermined criteria; and
combine patterns in said intermediate set of patterns to produce a multi-domain pattern that defines components of the e-business system.

24. The system of claim 23 further comprising a workstation communicatively linked to said server and said database.

25. The system of claim 23 wherein said controller is further adapted to display potential conflicts between said selected patterns.

26. The system of claim 23 wherein said controller is further adapted to store said predetermined criteria in said database.

27. The system of claim 23 wherein said controller is further adapted to store said intermediate set of patterns in said database.

28. A controller configured to:
display one or more domains to a user, wherein each said domain includes one or more patterns having domain specific information;
generate an intermediate set of patterns having selected patterns from said one or more domains according to a first criteria; and
combine patterns in said intermediate set of patterns to produce a multi-domain pattern that defines components of the e-business system.

29. The controller of claim 28 wherein said controller is further adapted to progressively refine said intermediate set of patterns according to a second criteria, said second criteria being narrower than said first criteria.

30. The method of claim 28 further comprising implementing said e-business system according to said multi-domain pattern.
